(19) United States
(12) Patent Application Publication
(10) Pub. No.: US 2026/0143428 A1
(43) Pub. Date: May 21, 2026

(54) PERIODIC CHANNEL STATE INFORMATION REPORTING IN A CONNECTED MODE DISCONTINUOUS RECEPTION CYCLE

(71) Applicant: QUALCOMM Incorporated, San Diego, CA (US)

(72) Inventors: Jung Ho RYU, Englewood Cliffs, NJ (US); Kazuki TAKEDA, Minato-ku (JP); Jelena DAMNJANOVIC, Del Mar, CA (US); Tao LUO, San Diego, CA (US)

(21) Appl. No.: 19/258,854

(22) Filed: Jul. 2, 2025

Related U.S. Application Data
(60) Provisional application No. 63/721,232, filed on Nov. 15, 2024.

(51) Int. Cl. H04W 52/02

(52) U.S. Cl. CPC H04W 52/0235; H04W 52/0274

(57) ABSTRACT

Methods, systems, and devices for wireless communications are described. A user equipment (UE) may receive, via a main radio of the UE, a control signal indicating configurations for a connected mode discontinuous reception (C-DRX) cycle including an on duration and an off duration, a low power wake up signal (LP-WUS) including a set of LP-WUS monitoring occasions and a corresponding set of communication windows, and periodic channel state information (CSI) reporting. The UE may monitor for the LP-WUS using a low power radio of the UE during the set of LP-WUS monitoring occasions. The UE may transmit a periodic CSI report during a communication window associated with a LP-WUS monitoring occasion based on the configuration for the periodic CSI reporting.

### CROSS REFERENCES

The present Application for Patent claims benefit of U.S. Provisional Patent Application No. 63/721,232 by RYU et al., entitled “PERIODIC CHANNEL STATE INFORMATION REPORTING IN A CONNECTED MODE DISCONTINUOUS RECEPTION CYCLE,” filed Nov. 15, 2024, assigned to the assignee hereof, and expressly incorporated herein.

### FIELD OF TECHNOLOGY

The following relates to wireless communications, including periodic channel state information (CSI) reporting in a connected mode discontinuous reception (C-DRX) cycle.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, via a main radio of the UE, a control signal indicating a first configuration for a connected mode discontinuous reception (C-DRX) cycle including an on duration and an off duration, a second configuration for a low power wake up signal (LP-WUS) that indicates a set of multiple LP-WUS monitoring occasions and a set of multiple communication windows that correspond to the set of multiple LP-WUS monitoring occasions, and a third configuration for periodic channel state information (CSI) reporting, monitoring for the LP-WUS using a low power radio of the UE during the set of multiple LP-WUS monitoring occasions based on the first configuration and the second configuration, and transmitting a periodic CSI report during a communication window of the set of multiple communication windows that is associated with a LP-WUS monitoring occasion of the set of multiple LP-WUS monitoring occasions based on the third configuration for the periodic CSI reporting.

A UE for wireless communications is described. The UE may include one or more memories storing processor executable code, and one or more processors coupled with the one or more memories. The one or more processors may individually or collectively be operable to execute the code to cause the UE to receive, via a main radio of the UE, a control signal indicating a first configuration for a C-DRX cycle including an on duration and an off duration, a second configuration for a LP-WUS that indicates a set of multiple LP-WUS monitoring occasions and a set of multiple communication windows that correspond to the set of multiple LP-WUS monitoring occasions, and a third configuration for periodic CSI reporting, monitor for the LP-WUS using a low power radio of the UE during the set of multiple LP-WUS monitoring occasions based on the first configuration and the second configuration, and transmit a periodic CSI report during a communication window of the set of multiple communication windows that is associated with a LP-WUS monitoring occasion of the set of multiple LP-WUS monitoring occasions based on the third configuration for the periodic CSI reporting.

Another UE for wireless communications is described. The UE may include means for receiving, via a main radio of the UE, a control signal indicating a first configuration for a C-DRX cycle including an on duration and an off duration, a second configuration for a LP-WUS that indicates a set of multiple LP-WUS monitoring occasions and a set of multiple communication windows that correspond to the set of multiple LP-WUS monitoring occasions, and a third configuration for periodic CSI reporting, means for monitoring for the LP-WUS using a low power radio of the UE during the set of multiple LP-WUS monitoring occasions based on the first configuration and the second configuration, and means for transmitting a periodic CSI report during a communication window of the set of multiple communication windows that is associated with a LP-WUS monitoring occasion of the set of multiple LP-WUS monitoring occasions based on the third configuration for the periodic CSI reporting.

A non-transitory computer-readable medium storing code for wireless communications is described. The code may include instructions executable by one or more processors to receive, via a main radio of the UE, a control signal indicating a first configuration for a C-DRX cycle including an on duration and an off duration, a second configuration for a LP-WUS that indicates a set of multiple LP-WUS monitoring occasions and a set of multiple communication windows that correspond to the set of multiple LP-WUS monitoring occasions, and a third configuration for periodic CSI reporting, monitor for the LP-WUS using a low power radio of the UE during the set of multiple LP-WUS monitoring occasions based on the first configuration and the second configuration, and transmit a periodic CSI report during a communication window of the set of multiple communication windows that is associated with a LP-WUS monitoring occasion of the set of multiple LP-WUS monitoring occasions based on the third configuration for the periodic CSI reporting.

In some examples of the method, UEs, and non-transitory computer-readable medium described herein, monitoring for the LP-WUS may include operations, features, means, or instructions for receiving the LP-WUS during the LP-WUS monitoring occasion, where the communication window may be triggered by the LP-WUS.

Some examples of the method, UEs, and non-transitory computer-readable medium described herein may further include operations, features, means, or instructions for monitoring for a downlink control channel signal during the communication window based on receiving the LP-WUS during the LP-WUS monitoring occasion.

In some examples of the method, UEs, and non-transitory computer-readable medium described herein, transmitting the periodic CSI report may include operations, features, means, or instructions for transmitting the periodic CSI report at each communication window that corresponds to an integer quantity of LP-WUS monitoring occasions of the set of multiple LP-WUS monitoring occasions.

In some examples of the method, UEs, and non-transitory computer-readable medium described herein, the third configuration for the periodic CSI reporting indicates the integer quantity of LP-WUS monitoring occasions.

In some examples of the method, UEs, and non-transitory computer-readable medium described herein, the integer quantity of LP-WUS monitoring occasions may be based on a periodicity of the C-DRX cycle.

In some examples of the method, UEs, and non-transitory computer-readable medium described herein, the periodic CSI report may be transmitted during each communication window of the set of multiple communication windows.

In some examples of the method, UEs, and non-transitory computer-readable medium described herein, the communication window may be a first communication window after an expiration of a periodic CSI reporting timer indicated via the third configuration for the periodic CSI reporting.

Some examples of the method, UEs, and non-transitory computer-readable medium described herein may further include operations, features, means, or instructions for transmitting a second periodic CSI report during the on duration of the C-DRX cycle based on a periodicity of the C-DRX cycle.

In some examples of the method, UEs, and non-transitory computer-readable medium described herein, the second periodic CSI report may be transmitted during the on duration of the C-DRX cycle based on an absence of a periodic CSI reporting timer in the third configuration for the periodic CSI reporting.

In some examples of the method, UEs, and non-transitory computer-readable medium described herein, the second configuration for the LP-WUS indicates a timer duration for the set of multiple communication windows.

In some examples of the method, UEs, and non-transitory computer-readable medium described herein, the second configuration for the LP-WUS indicates a time offset between each of the set of multiple LP-WUS monitoring occasions and the set of multiple communication windows.

In some examples of the method, UEs, and non-transitory computer-readable medium described herein, the third configuration for the periodic CSI reporting configures the UE to refrain from transmitting the periodic CSI report unless the UE receives the LP-WUS.

In some examples of the method, UEs, and non-transitory computer-readable medium described herein, the third configuration for the periodic CSI reporting configures the UE to transmit the periodic CSI report independent from a reception of the LP-WUS.

In some examples of the method, UEs, and non-transitory computer-readable medium described herein, the periodic CSI report may be transmitted during the off duration of the C-DRX cycle.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports periodic channel state information (CSI) reporting in a connected mode discontinuous reception (C-DRX) cycle in accordance with one or more aspects of the present disclosure.

FIG. 2 shows an example of a wireless communications system that supports periodic CSI reporting in a C-DRX cycle in accordance with one or more aspects of the present disclosure.

FIG. 3 shows an example of a process flow that supports periodic CSI reporting in a C-DRX cycle in accordance with one or more aspects of the present disclosure.

FIGS. 4 and 5 show block diagrams of devices that support periodic CSI reporting in a C-DRX cycle in accordance with one or more aspects of the present disclosure.

FIG. 6 shows a block diagram of a communications manager that supports periodic CSI reporting in a C-DRX cycle in accordance with one or more aspects of the present disclosure.

FIG. 7 shows a diagram of a system including a device that supports periodic CSI reporting in a C-DRX cycle in accordance with one or more aspects of the present disclosure.

FIGS. 8 through 10 show flowcharts illustrating methods that support periodic CSI reporting in a C-DRX cycle in accordance with one or more aspects of the present disclosure.

### DETAILED DESCRIPTION

In some wireless communications systems, a user equipment (UE) may be configured for a connected mode discontinuous reception (C-DRX) cycle. The UE may monitor for control signaling during an on duration of the C-DRX cycle, which may schedule the UE to transmit or receive signaling from a network entity. During the off duration of the C-DRX cycle, the UE may turn off a main radio at the UE to reduce power consumption. The UE may be equipped with a low power radio or low power receiver, which the UE may use to monitor for low power signaling, such as a low power wake up signal (LP-WUS) or a low power synchronization signal (LP-SS), during the off duration of the C-DRX cycle. The network entity may transmit an LP-WUS to the UE during an LP-WUS monitoring occasion to indicate that the UE is to turn on the main radio and monitor for control signaling during a communication window that is offset in time from the LP-WUS monitoring occasion. In some examples, the UE may be configured to report periodic channel state information (CSI). In some systems, the UE may report periodic CSI during the on duration of the C-DRX cycle. However, if the C-DRX cycle has a long periodicity, the CSI may be outdated when the UE has an opportunity to transmit the periodic CSI report.

A wireless communication system described herein may support efficient techniques for a UE to transmit a periodic CSI report while configured to operate according to a C-DRX cycle. In some examples, the UE may transmit the periodic CSI report during a communication window that is associated with an LP-WUS monitoring occasion. If the UE is configured to not report periodic CSI if the UE is not indicated to wake up, the UE may transmit a periodic CSI report during a communication window that is triggered by an LP-WUS. For example, if the UE receives an LP-WUS, the LP-WUS may trigger a communication window, and the UE may transmit the CSI report via an uplink channel during the communication window. In some other examples, the UE may be configured to report periodic CSI regardless of whether the UE in indicated to wake up, or regardless of whether the UE has received an LP-WUS. The UE may transmit the periodic CSI report in a communication window that is associated with an LP-WUS monitoring occasion, even if the UE does not receive an LP-WUS in the LP-WUS monitoring occasion. In some examples, the UE may transmit the periodic CSI report with a periodicity that corresponds to a periodicity of the LP-WUS. For example, the UE may transmit the periodic CSI report during a communication window associated with every Nth LP-WUS monitoring occasion. In some examples, the UE may transmit the periodic CSI report during an active time of the C-DRX cycle. For example, if the UE receives an LP-WUS that triggers the UE to communicate during a communication window, the communication window may be part of the active time of the C-DRX cycle. In some examples, if a periodicity of the C-DRX cycle satisfies a threshold, the UE may transmit the periodic CSI report during an on duration of the C-DRX cycle. Additional, or alternative, techniques for transmitting a periodic CSI report when configured for a C-DRX cycle are described herein.

Aspects of the disclosure are initially described in the context of wireless communications systems. Aspects of the disclosure are further illustrated by and described with reference to apparatus diagrams, system diagrams, and flowcharts that relate to periodic CSI reporting in a C-DRX cycle.

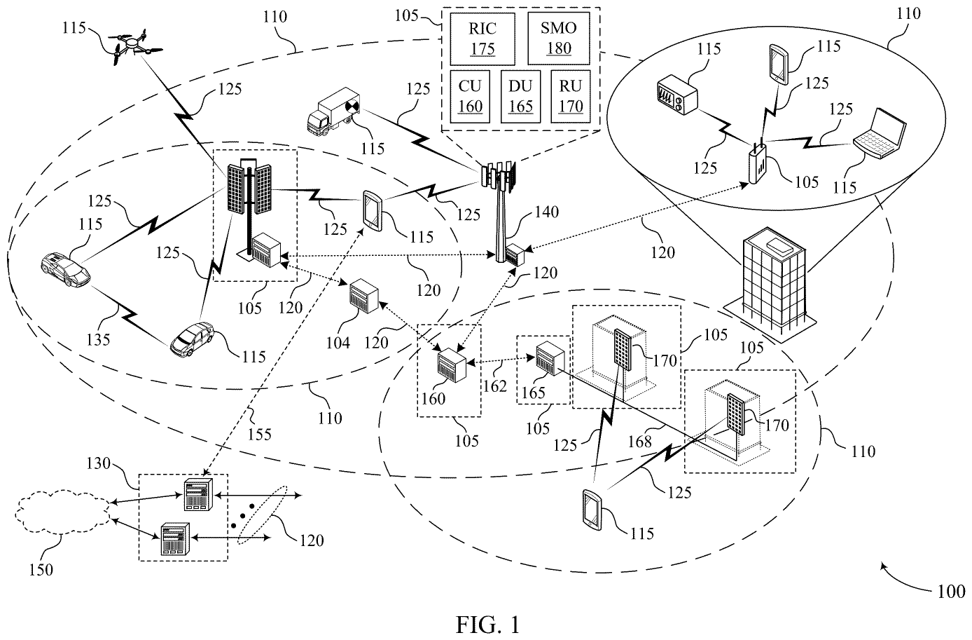

FIG. 1 shows an example of a wireless communications system 100 that supports periodic CSI reporting in a C-DRX cycle in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support periodic CSI reporting in a C-DRX cycle as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may operate according to a DRX cycle while the UE 115 operating in a connected RRC mode. The DRX cycle for when the UE 115 is operating in an RRC connected mode may be referred to as a C-DRX cycle. The UE 115 may monitor a physical downlink control channel (PDCCH) on a serving cell during an active time of the C-DRX cycle. For example, at the start of the C-DRX cycle, the UE 115 may initialize an on duration timer, such as drx-OnDurationTimer, and the UE 115 may monitor for PDCCH signaling from one or more serving cells associated with the C-DRX cycle. When the on duration timer expires, the on duration of the C-DRX cycle may expire.

If the UE 115 receives a PDCCH signal that indicates a new transmission on a serving cell associated with the C-DRX cycle, the UE 115 may start or restart an inactivity timer. For example, the UE 115 may receive a PDCCH signal that schedules the UE 115 to receive downlink signaling, transmit uplink signaling, or communicate (e.g., transmit or receive, or both) sidelink signaling. If the UE 115 receives a PDCCH signal and starts or restarts the inactivity timer, the active duration of the C-DRX timer may be extended until an expiration of both the on duration timer and the inactivity timer. For example, receiving a PDCCH signal that indicates a new transmission may extend the active time of the C-DRX cycle past an expiration of the on duration timer.

When the on duration timer expires and, if initialized, the inactivity timer expires, the UE 115 may be in an off duration of the C-DRX cycle. During the off duration of the C-DRX cycle, the UE 115 may enter a lower power state to conserve energy or reduce power consumption.

In some examples, a UE 115 may be equipped with a main radio and a low power radio. The main radio may be used for communications (e.g., transmission and reception) with other devices, such as communications via physical control channels or physical shared channels. The low power radio may be used to receive low power signals, such as an LP-SS or an LP-WUS. In some examples, the low power radio may be a low power receiver. For example, the low power radio may not include components for transmission in some cases.

In some cases, the UE 115 may turn off power to the main radio when the UE 115 is operating in the off duration of a C-DRX cycle. Turning off the main radio may enable the UE 115 to enter a deep sleep mode and reduce energy consumption. With the main radio off, the UE 115 may use the low power radio to monitor for LP-WUS. The low power radio may use less power than the main radio. If a network entity 105 transmits an LP-WUS, and the UE 115 receives the LP-WUS, the UE 115 may wake up, or switch on, the main radio and receive a control message from the network entity 105. For example, the LP-WUS may trigger the UE 115 to monitor for PDCCH signaling in a PDCCH monitoring occasion using the main radio.

Low power signals, such as the LP-WUS and the LP-SS, may transmitted using an on-off keying (OOK) waveform. In a base band, an OOK waveform may be a sequence of high power or high amplitude durations (e.g., “on” durations) and low power or low amplitude durations (e.g., “off” durations). An OFDM sequence may be overlaid on an OOK sequence (e.g., for “on” durations of the OOK waveform), and the network entity 105 may transmit the OFDM sequence overlaid on the OOK sequence to transmit the low power signal. The overlaid OFDM sequence may be, for example, a Gold sequence, an M sequence, a computer searched sequence, or a Zadoff-Chu sequence, or any combination thereof.

The OOK waveform may be an OOK-1 waveform or an OOK-4 waveform. An OOK-1 waveform may convey 1 bit of information in 1 OFDM symbol. An OOK-4 waveform may convey M bits of information in 1 OFDM symbol. For example, an OOK-4 waveform may include 2 OOK symbols per OFDM symbol (e.g., M=2) or 4 OOK symbols per OFDM symbol (e.g., M=4). In some cases, such as in a Frequency Range 1 radio frequency spectrum band, an LP-WUS may span 11 physical resource blocks (PRBs) with a 30 kHz subcarrier spacing.

A network entity 105 may periodically transmit LP-SS using multiple beams. LP-SS may enable UEs 115 operating in a deep sleep mode to maintain time and frequency synchronization. A synchronization signal block (SSB), received by UEs 115 using the main radio, may not be an OOK waveform and may not receivable or processable using the low power radio.

In some examples, an LP-WUS may trigger a UE 115 operating according to a C-DRX configuration to monitor for PDCCH signaling in a PDCCH monitoring occasion. In some examples, the UE 115 may monitor for LP-WUS according to an LP-WUS monitoring configuration before the UE 115 starts a DRX on duration timer to trigger a start of the DRX on duration timer.

In some examples, the UE 115 may monitor for LP-WUS outside of the DRX on duration time according to the LP-WUS monitoring configuration to trigger PDCCH monitoring. For example, the UE 115 may perform PDCCH monitoring triggered by reception of LP-WUS irrespective of the DRX on duration timer. In some examples, PDCCH monitoring may also be triggered based on the C-DRX cycle and the DRX on duration timer. In some examples, PDCCH monitoring may not be triggered by the C-DRX cycle and the DRX on duration timer when the UE 115 monitors for an LP-WUS. In some examples, the UE 115 may monitor for LP-WUS at least within a C-DRX active time according to an LP-WUS monitoring configuration to trigger PDCCH monitoring.

In some examples, a UE 115 may be configured for periodic CSI reporting. For example, the UE 115 may measure reference signals and periodically transmit a CSI report indicating L1 reference signal received power (RSRP) measurements of the reference signals. The UE 115 may be configured for periodic CSI reporting while the UE 115 is configured with a C-DRX cycle. In some examples, the UE 115 may be configured to not to report periodic CSI or L1-RSRP measurements if the UE 115 is not indicated to wake up. For example, if the UE 115 does not receive an LP-WUS indicating for the UE 115 to wake up, the UE 115 may not report periodic CSI. In some other examples, the UE 115 may be configured to report periodic CSI or L1-RSRP measurements regardless of whether the UE 115 is indicated to wake up. For example, the UE 115 may report periodic CSI even if the UE 115 does not receive an LP-WUS indicating for the UE 115 to wake up.

In some examples, a network entity 105 may transmit a control signal indicating one or more configurations to a UE 115, including a first configuration for the C-DRX cycle, a second configuration for an LP-WUS, or a third configuration for periodic CSI reporting, or any combination thereof. Additionally, or alternatively, these configurations may be indicated via different signaling or control signals. In some examples, the control signal may be an example of an RRC signal or indicate an RRC message. The first configuration for the C-DRX cycle may include, for example, an on duration timer, an inactivity timer, a slot offset (e.g., between a start of a C-DRX cycle and a start of an active time or a start of the on duration timer), a periodicity of the C-DRX cycle, or any combination thereof. The second configuration for the LP-WUS may include scheduling information for LP-WUS monitoring occasions, scheduling information for communication windows in which the UE 115 monitors for PDCCH if the UE 115 receives LP-WUS in the corresponding LP-WUS monitoring occasion, a time offset between an LP-WUS monitoring occasion and a communication window, a timer duration for the communication windows, or any combination thereof. The third configuration for the periodic CSI reporting may include a periodicity of the periodic CSI reporting, a periodic CSI report timer which triggers transmission of a CSI report, measurements to be reported by the periodic CSI report, a configuration of whether the UE 115 is to report periodic CSI regardless of receiving an LP-WUS while operating according to a C-DRX cycle, refrain from reporting CSI if the UE 115 does not receive an LP-WUS while operating according to a C-DRX cycle, or any combination thereof.

In some systems, the UE 115 may transmit a periodic CSI report during an on duration of the C-DRX cycle. However, if a periodicity of the C-DRX cycle is long, there may be delay between the UE 115 obtaining the measurements and transmitting the CSI report. For example, if the C-DRX has a long periodicity, channel conditions may change between the UE 115 obtaining the L1-RSRP measurements and transmitting the periodic CSI report in a next on duration of the C-DRX cycle. As such, the CSI may be outdated by the time the UE 115 transmits the periodic CSI report.

The wireless communications system 100 may support efficient techniques for a UE 115 to transmit a periodic CSI report while configured to operate according to a C-DRX cycle. In some examples, the UE 115 may transmit the periodic CSI report during a communication window that is associated with an LP-WUS monitoring occasion. If the UE 115 is configured to not report periodic CSI if the UE 115 is not indicated to wake up, the UE 115 may transmit a periodic CSI report during a communication window that is triggered by an LP-WUS. For example, if the UE 115 receives an LP-WUS, the LP-WUS may trigger a communication window, and the UE 115 may transmit the CSI report via an uplink channel during the communication window. In some other examples, the UE 115 may be configured to report periodic CSI regardless of whether the UE 115 in indicated to wake up, or regardless of whether the UE 115 has received an LP-WUS. The UE 115 may transmit the periodic CSI report in a communication window that is associated with an LP-WUS monitoring occasion, even if the UE 115 does not receive an LP-WUS in the LP-WUS monitoring occasion. In some examples, the UE 115 may transmit the periodic CSI report with a periodicity that corresponds to a periodicity of the LP-WUS. For example, the UE 115 may transmit the periodic CSI report during a communication window associated with every Nth LP-WUS monitoring occasion. In some examples, the UE 115 may transmit the periodic CSI report during an active time of the C-DRX cycle. For example, the communication window may be part of the active time, such as an active time of the C-DRX cycle that is during the off duration of the C-DRX cycle. In some examples, if a periodicity of the C-DRX cycle satisfies a threshold, the UE 115 may transmit the periodic CSI report during an on duration of the C-DRX cycle. Additional, or alternative, techniques for transmitting a periodic CSI report when configured for a C-DRX cycle are described herein.

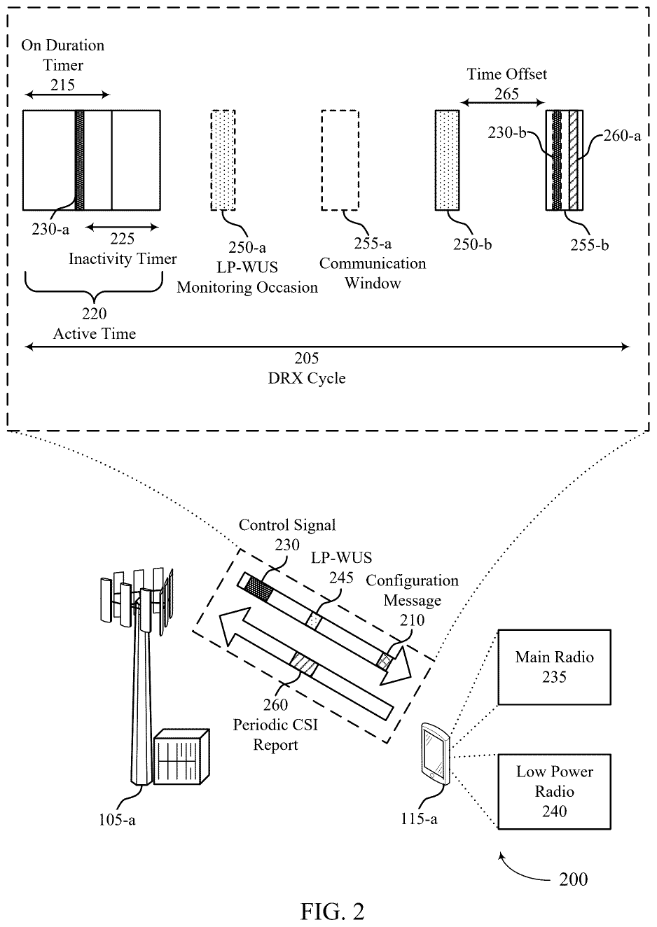

FIG. 2 shows an example of a wireless communications system 200 that supports periodic CSI reporting in a C-DRX cycle in accordance with one or more aspects of the present disclosure. The wireless communications system 200 may implement aspects of a wireless communications system 100. For example, the wireless communications system 200 may include a UE 115-a and a network entity 105-a, which may be respective examples of a UE 115 and a network entity 105 described herein.

The UE 115-a may be configured to operate according to a C-DRX cycle 205. For example, the network entity 105-a may transmit a configuration message 210 that indicates a first configuration for the C-DRX cycle 205. The configuration for the C-DRX cycle may indicate a periodicity for the C-DRX cycle 205 and an on duration timer 215. During an active time 220 of the C-DRX cycle, the UE 115-a may monitor for PDCCH a serving cell, such as the serving cell provided by the network entity 105-a. In some examples, the active time 220 may begin when the UE 115-a initiates the on duration timer 215.

In some examples, the first configuration for the C-DRX cycle may include an inactivity timer 225. If the UE 115-a receives PDCCH signaling that indicates a new transmission on a serving cell associated with the C-DRX cycle 205, the UE 115-a may start or restart the inactivity timer 225. For example, the UE 115-a may receive a control signal 230 that schedules the UE 115-a to receive downlink signaling, transmit uplink signaling, or communicate (e.g., transmit or receive, or both) sidelink signaling. In some examples, the control signal 230 may include a grant for uplink resources, downlink resources, or sidelink resources.

If the UE 115-a receives a PDCCH signal and starts or restarts the inactivity timer, the active time 220 of the C-DRX cycle 205 may be extended until an expiration of both the on duration timer 215 and the inactivity timer 225. For example, receiving a PDCCH signal, such as a control signal 230-a, that indicates a new transmission may extend the active time 220 of the C-DRX cycle 205 past an expiration of the on duration timer 215 until the inactivity timer 225 expires.

When the active time 220 expires or is over, the UE 115-a may be in an off duration of the C-DRX cycle 205. During the off duration of the C-DRX cycle 205, the UE 115-a may enter a lower power state to conserve energy or reduce power consumption.

The UE 115-a may be equipped with a main radio 235 and a low power radio 240. The main radio 235 may be used for communications (e.g., transmission and reception) with other devices, such as communications via physical control channels or physical shared channels. The low power radio 240 may be used to receive low power signals, such as an LP-SS or an LP-WUS 245. In some examples, the active time 220 may correspond to when the UE 115-a is operating the main radio 235, such as to communicate uplink or downlink signaling using the main radio 235.

In some cases, the UE 115-a may turn off power to the main radio 235 when the UE 115-a is operating in the off duration of the C-DRX cycle 205. Turning off the main radio 235 may enable the UE 115-a to enter a deep sleep mode and reduce energy consumption. With the main radio 235 off, the UE 115-a may use the low power radio 240 to monitor for LP-WUS 245. If the network entity 105-a transmits an LP-WUS 245, and the UE 115-a receives the LP-WUS 245, the UE 115-a may wake up, or switch on, the main radio 235 and receive a control signal 230 from the network entity 105-a. For example, the LP-WUS 245 may trigger the UE 115-a to monitor for PDCCH signaling in a PDCCH monitoring occasion using the main radio 235.

The configuration message 210 may indicate a configuration for low power signals, such as the LP-WUS 245 or an LP-SS, or both. The configuration for low power signals may indicate LP-WUS monitoring occasions 250. The UE 115-a may monitor the LP-WUS monitoring occasions 250 according to the configuration for LP-WUS 245. The configuration for low power signals may also indicate resource or scheduling information for one or more communication windows. If the UE 115-a detects an LP-WUS 245 in an LP-WUS monitoring occasion 250, the UE 115-a may monitor for PDCCH signaling in a communication window 255 that corresponds to the LP-WUS monitoring occasion 250. For example, the communication window 255 may be offset in time from the LP-WUS monitoring occasion 250. In some examples, the configuration for low power signals may indicate a time offset 265 between an LP-WUS monitoring occasion 250 and a communication window 255. In some examples, the configuration for low power signals may indicate a timer that corresponds to a duration of a communication window 255.

In some examples, the UE 115-a may be configured for periodic CSI reporting. For example, the configuration message 210 may indicate a third configuration for periodic CSI reporting. The UE 115-a may measure reference signals and periodically transmit a periodic CSI report 260 indicating L1-RSRP measurements of the reference signals.

The UE 115-a may be configured for periodic CSI reporting while the UE 115-a is configured with the C-DRX cycle 205. In some examples, the UE 115-a may be configured to not to report periodic CSI or L1-RSRP measurements if the UE 115-a is not indicated to wake up. For example, if the UE 115-a does not receive an LP-WUS 245 indicating for the UE 115-a to wake up, the UE 115-a may not transmit the periodic CSI report 260. If the UE 115-a does receive an LP-WUS 245 in an LP-WUS monitoring occasion 250 that indicates for the UE 115-a to wake up, the UE 115-a may transmit the periodic CSI report 260 to the network entity 105-a during a communication window 255 associated with the LP-WUS monitoring occasion 250.

For example, the UE 115-a may enter a low power mode after the active time 220 and monitor the LP-WUS monitoring occasions 250. The UE 115-a may not receive an LP-WUS 245 during an LP-WUS monitoring occasion 250-a, so the UE 115-a may not transmit the periodic CSI report 260 in the communication window 255-a that is associated with the LP-WUS monitoring occasion 250-a. The UE 115-a may receive an LP-WUS 245 in an LP-WUS monitoring occasion 250-b, so the UE 115-a may transmit a periodic CSI report 260-a in a communication window 255-b that is associated with the LP-WUS monitoring occasion 250-b. In some examples, a communication window 255, such as the communication window 255-b, may be part of an active time of the C-DRX cycle 205 that is during the off duration of the C-DRX cycle 205. The UE 115-a may transmit the periodic CSI report 260-a to the network entity 105-a via PUCCH during the communication window 255-b starting from a slot where a timer triggered by the LP-WUS starts. For example, after a time offset 265 from the LP-WUS monitoring occasion 250-b, the UE 115-a may start a timer corresponding to a duration of the communication window 255-b. The UE 115-a may transmit the periodic CSI report 260-a via uplink resources during the communication window 255-b.

In some examples, the UE 115-a may monitor for a control signal in the communication window 255-b based on receiving the LP-WUS 245 in the LP-WUS monitoring occasion 250-b. For example, the network entity 105-b may transmit the LP-WUS 245 during the LP-WUS monitoring occasion 250-b to indicate that the UE 115-a is to wake up and receive a control signal 230-b during the communication window 255-b.

In some examples, the UE 115-a may be configured to transmit the periodic CSI report 260 regardless of whether the UE 115-a is indicated to wake up or not. For example, the UE 115-a may transmit the periodic CSI report 260 even if the UE 115-a does not receive an LP-WUS 245 indicating for the UE 115-a to wake up.

In some examples, the UE 115-a may transmit the periodic CSI report 260 during a time window that corresponds to the on duration timer 215. For example, if the UE 115-a is not configured with a periodicity for reporting periodic CSI when the UE 115-a is monitoring for LP-WUS 245, the UE 115-a may transmit the periodic CSI report 260 in a time window starting from a slot where the on duration timer 215 would start based on the C-DRX configuration. In some examples, the UE 115-a may report the periodic CSI report 260 during the on duration, or in a window corresponding to the on duration timer 215, if a periodicity of the C-DRX cycle 205 satisfies a threshold. For example, if the periodicity of the C-DRX cycle 205 is less than 500 milliseconds, the UE 115-a may transmit the periodic CSI report 260 during the on duration of the C-DRX cycle 205. If the periodicity of the C-DRX cycle 205 fails to satisfy the threshold (e.g., the periodicity of the C-DRX cycle 205 is above 500 milliseconds), the network entity 105-a may configure the UE 115-a with a separate periodicity for reporting periodic CSI.

In some examples, the UE 115-a may report periodic CSI based on a periodicity of the LP-WUS 245 or a periodicity of the LP-WUS monitoring occasions 250. For example, the UE 115-a may transmit the periodic CSI report 260 at a periodicity that corresponds to an integer multiple of the periodicity of the LP-WUS 245. For example, if the LP-WUS 245 has a periodicity of 20 milliseconds (e.g., there are LP-WUS monitoring occasions 250 every 20 milliseconds), the UE 115-a may report periodic CSI with a periodicity of N*20 milliseconds, where N is an integer value.

In some examples, the network entity 105-a may configure a value for N. For example, the network entity 105-a may indicate the value for N via the configuration message 210, such as in the periodic CSI reporting configuration. Additionally, or alternatively, the value for N may be based on a periodicity of the C-DRX cycle 205. For example, if the C-DRX cycle is 128 millisecond, N may be configured to approximate the length of the C-DRX cycle. In this example, if the LP-WUS has a periodicity of 20 milliseconds, N may be set to 6, and the CSI reporting periodicity is 120 milliseconds. With N set to 6, the UE 115-a may transmit the periodic CSI report 260 after every sixth LP-WUS monitoring occasion 250. In some examples, the network entity 105-a may configure a periodicity for transmitting a periodic CSI report 260, and the UE 115-a may transmit the periodic CSI report 260 according to the configured periodic CSI report transmission periodicity. In some examples, the network entity 105-a may configure a timer for transmitting the periodic CSI report 260, and the UE 115-a may transmit the periodic CSI report 260 upon expiration of the configured timer for transmitting the periodic CSI report 260.

In some examples, if the UE 115-a is configured to transmit the periodic CSI report 260 even if the UE 115-a is not indicated to wake up, the UE 115-a may transmit the periodic CSI report 260 during a communication window 255 that is associated with an LP-WUS monitoring occasion 250. For example, the UE 115-a may transmit the periodic CSI report 260 in a communication window 255 corresponds to every Nth LP-WUS monitoring occasion 250.

In some examples, the UE 115-a may transmit the periodic CSI report 260 during each communication window 255. For example, the UE 115-a may not receive an LP-WUS 245 in the LP-WUS monitoring occasion 250-a, but the UE 115-a may transmit a periodic CSI report 260 during the communication window 255-a. The UE 115-a may receive an LP-WUS 245 in the LP-WUS monitoring occasion 250-b, and the UE 115-a may transmit a periodic CSI report 260-a during the communication window 255-b. In some examples, this may correspond to periodic CSI reporting with an N value set to 1, or reporting periodic CSI after every LP-WUS monitoring occasion 250.

In some examples, the configuration message for periodic CSI reporting may configure the UE 115-a with a timer that corresponds to a periodicity for reporting CSI. The UE 115-a may transmit the periodic CSI report 260 in a next communication window after the timer expires. For example, if the timer that corresponds to periodic CSI reporting expires between the communication window 255-a and the LP-WUS monitoring occasion 250-b, the UE 115-a may transmit the periodic CSI report 260-a during the communication window 255-b. Once the UE 115-a transmits the periodic CSI report 260, the UE 115-a may restart the timer for periodic CSI reporting.

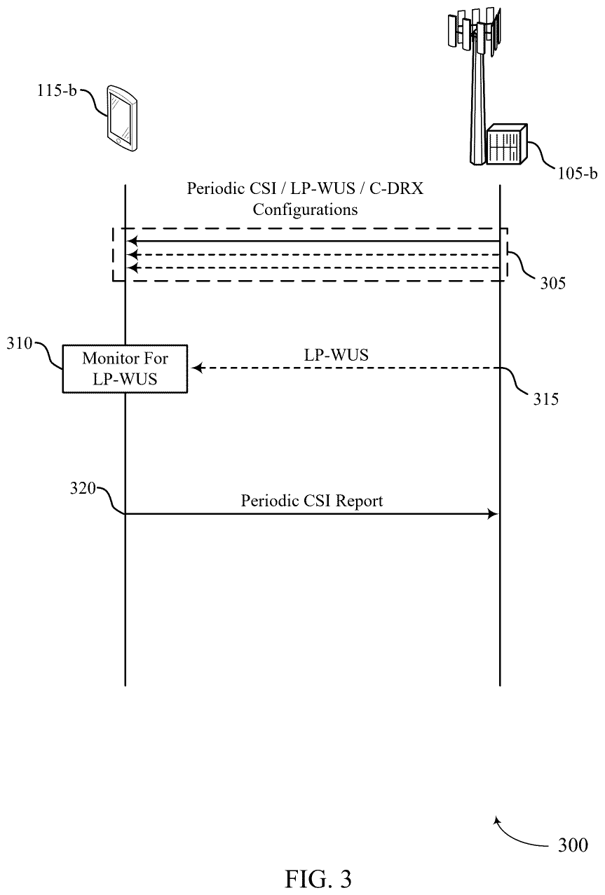

FIG. 3 shows an example of a process flow 300 that supports periodic CSI reporting in a C-DRX cycle in accordance with one or more aspects of the present disclosure. The process flow 300 may implement aspects of a wireless communications system 100 and a wireless communications system 200 described herein. For example, the process flow 300 may be implemented by a UE 115-b and a network entity 105-b, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 300, some aspects of some operations may also be performed by one or more other wireless devices.

At 305, the UE 115-b may receive a control signal indicating one or more configurations for a C-DRX cycle, an LP-WUS, and periodic CSI reporting. For example, the UE 115-b may receive the control signal indicating a first configuration for a C-DRX cycle including an on duration and an off duration, a second configuration for an LP-WUS that indicates a set of LP-WUS monitoring occasions and a set of communication windows that corresponds to the set of LP-WUS monitoring occasions, and a third configuration for periodic CSI reporting. In some other examples, different control signals may indicate the configurations.

At 310, the UE 115-b may monitor for an LP-WUS using a low power radio of the UE 115-b. The UE 115-b may monitor for the LP-WUS during the set of LP-WUS monitoring occasions based on the first configuration and the second configuration.

In some examples, the UE 115-b may be configured not to report periodic CSI or L1-RSRP if the UE 115-b is not indicated to wake up. For example, the third configuration for the periodic CSI reporting may configure the UE 115-b to refrain from transmitting the periodic CSI report unless the UE 115-b receives the LP-WUS.

In some examples, the network entity 105-b may transmit the LP-WUS to the UE 115-b at 315. The UE 115-b may receive the LP-WUS during an LP-WUS monitoring occasion. The LP-WUS may trigger a communication window of the set of communication windows that corresponds to the LP-WUS monitoring occasion. The UE 115-b may transmit a periodic CSI report during the communication window based on the third configuration of the periodic CSI reporting. For example, the UE 115-b may transmit the periodic CSI report at 320 during the communication window based on receiving the LP-WUS during the LP-WUS monitoring occasion that corresponds to the communication window and the third configuration for periodic CSI reporting configuring the UE 115-b to report periodic CSI when the UE 115-b is indicated to wake up.

In some examples, the UE 115-b may be configured to report periodic CSI or L1-RSRP regardless of whether the UE 115-b is indicated to wake up. For example, the third configuration for the periodic CSI reporting may configure the UE 115-b to transmit the periodic CSI report independent from a reception of the LP-WUS.

The UE 115-b may monitor for the LP-WUS at 310, but the network entity 105-b may not transmit the LP-WUS at 315. However, the UE 115-b may be configured to transmit the CSI report at 315. For example, the UE 115-b may transmit the periodic CSI report at each communication window that corresponds to an integer quantity of LP-WUS monitoring occasions of the set of LP-WUS monitoring occasions. In some examples, the third configuration for the periodic CSI reporting may indicate the integer quantity of LP-WUS monitoring occasions. For example, the UE 115-b may be configured to transmit the periodic CSI report after every Nth LP-WUS monitoring occasion. A value for N, or the integer value, may be configured by the network entity 105-b via the third configuration for periodic CSI reporting. In some examples, the value for N, or the integer quantity, may be configured based on a periodicity of the C-DRX cycle. In some examples, the UE 115-b may transmit a periodic CSI report during each communication window of the set of communication windows.

In some cases, the communication window may be a first communication window after an expiration of a periodic CSI timer. For example, the third configuration for the periodic CSI reporting may configure the UE 115-b with the periodic CSI timer. When the periodic CSI timer expires, the UE 115-b may transmit the periodic CSI report during a next communication window. After transmitting the periodic CSI report, the UE 115-b may reset the periodic CSI timer.

In some examples, the UE 115-b may transmit the periodic CSI report during an on duration of the C-DRX cycle. The UE 115-b may transmit the periodic CSI report during the on duration of the C-DRX cycle if a periodicity or duration of the C-DRX cycle satisfies a threshold. For example, if the periodicity of the C-DRX cycle is shorter than a threshold length of time, the UE 115-b may transmit the periodic CSI report during the on duration of the C-DRX cycle.

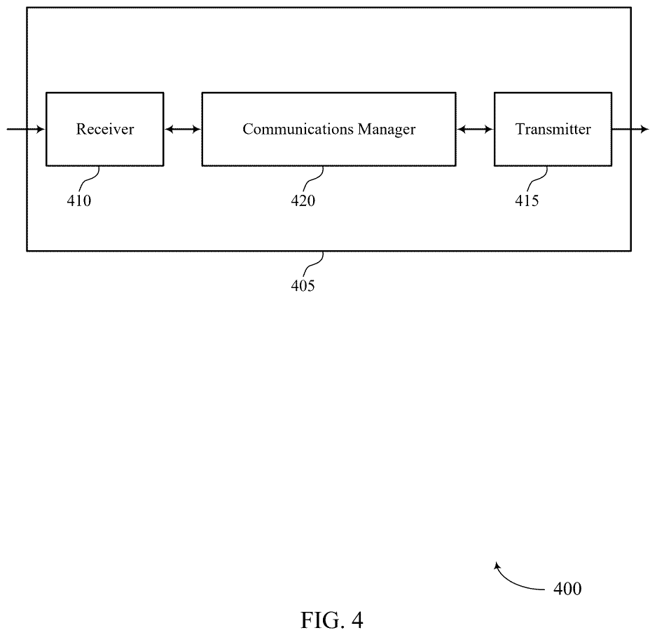

FIG. 4 shows a block diagram 400 of a device 405 that supports periodic CSI reporting in a C-DRX cycle in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to periodic CSI reporting in a C-DRX cycle). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to periodic CSI reporting in a C-DRX cycle). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of periodic CSI reporting in a C-DRX cycle as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving, via a main radio of the UE, a control signal indicating a first configuration for a C-DRX cycle including an on duration and an off duration, a second configuration for a LP-WUS that indicates a set of multiple LP-WUS monitoring occasions and a set of multiple communication windows that correspond to the set of multiple LP-WUS monitoring occasions, and a third configuration for periodic CSI reporting. The communications manager 420 is capable of, configured to, or operable to support a means for monitoring for the LP-WUS using a low power radio of the UE during the set of multiple LP-WUS monitoring occasions based on the first configuration and the second configuration. The communications manager 420 is capable of, configured to, or operable to support a means for transmitting a periodic CSI report during a communication window of the set of multiple communication windows that is associated with a LP-WUS monitoring occasion of the set of multiple LP-WUS monitoring occasions based on the third configuration for the periodic CSI reporting.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption.

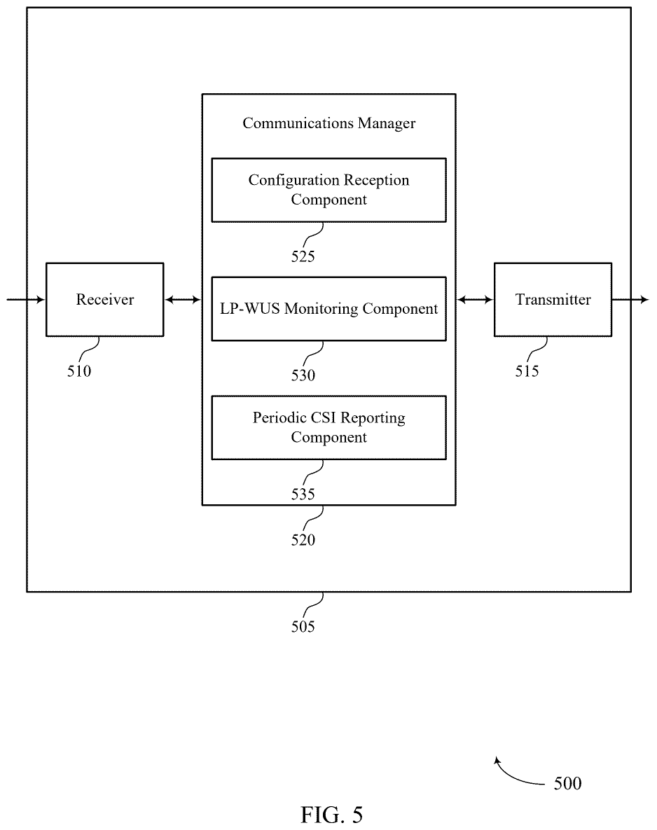

FIG. 5 shows a block diagram 500 of a device 505 that supports periodic CSI reporting in a C-DRX cycle in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to periodic CSI reporting in a C-DRX cycle). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to periodic CSI reporting in a C-DRX cycle). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of periodic CSI reporting in a C-DRX cycle as described herein. For example, the communications manager 520 may include a configuration reception component 525, an LP-WUS monitoring component 530, a periodic CSI reporting component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The configuration reception component 525 is capable of, configured to, or operable to support a means for receiving, via a main radio of the UE, a control signal indicating a first configuration for a C-DRX cycle including an on duration and an off duration, a second configuration for a LP-WUS that indicates a set of multiple LP-WUS monitoring occasions and a set of multiple communication windows that correspond to the set of multiple LP-WUS monitoring occasions, and a third configuration for periodic CSI reporting. The LP-WUS monitoring component 530 is capable of, configured to, or operable to support a means for monitoring for the LP-WUS using a low power radio of the UE during the set of multiple LP-WUS monitoring occasions based on the first configuration and the second configuration. The periodic CSI reporting component 535 is capable of, configured to, or operable to support a means for transmitting a periodic CSI report during a communication window of the set of multiple communication windows that is associated with a LP-WUS monitoring occasion of the set of multiple LP-WUS monitoring occasions based on the third configuration for the periodic CSI reporting.

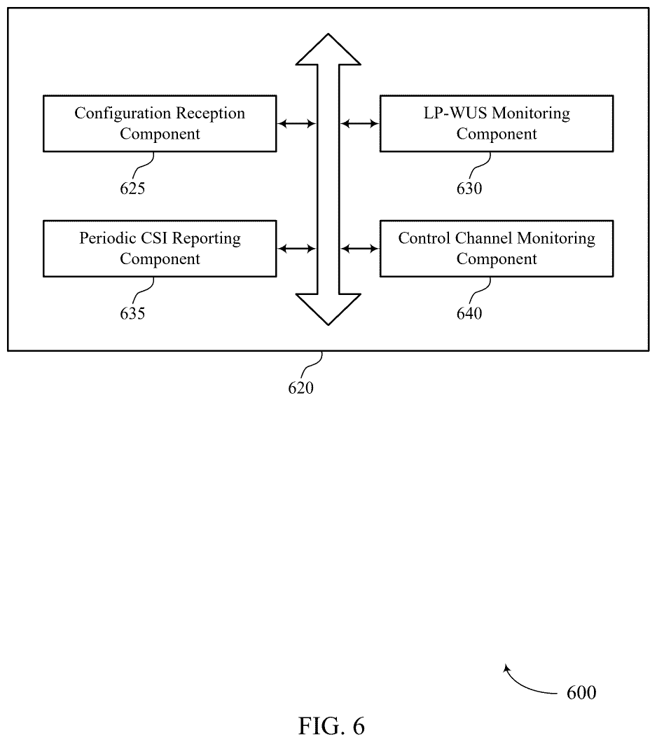

FIG. 6 shows a block diagram 600 of a communications manager 620 that supports periodic CSI reporting in a C-DRX cycle in accordance with one or more aspects of the present disclosure. The communications manager 620 may be an example of aspects of a communications manager 420, a communications manager 520, or both, as described herein. The communications manager 620, or various components thereof, may be an example of means for performing various aspects of periodic CSI reporting in a C-DRX cycle as described herein. For example, the communications manager 620 may include a configuration reception component 625, an LP-WUS monitoring component 630, a periodic CSI reporting component 635, a control channel monitoring component 640, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The configuration reception component 625 is capable of, configured to, or operable to support a means for receiving, via a main radio of the UE, a control signal indicating a first configuration for a C-DRX cycle including an on duration and an off duration, a second configuration for a LP-WUS that indicates a set of multiple LP-WUS monitoring occasions and a set of multiple communication windows that correspond to the set of multiple LP-WUS monitoring occasions, and a third configuration for periodic CSI reporting. The LP-WUS monitoring component 630 is capable of, configured to, or operable to support a means for monitoring for the LP-WUS using a low power radio of the UE during the set of multiple LP-WUS monitoring occasions based on the first configuration and the second configuration. The periodic CSI reporting component 635 is capable of, configured to, or operable to support a means for transmitting a periodic CSI report during a communication window of the set of multiple communication windows that is associated with a LP-WUS monitoring occasion of the set of multiple LP-WUS monitoring occasions based on the third configuration for the periodic CSI reporting.

In some examples, to support monitoring for the LP-WUS, the LP-WUS monitoring component 630 is capable of, configured to, or operable to support a means for receiving the LP-WUS during the LP-WUS monitoring occasion, where the communication window is triggered by the LP-WUS.

In some examples, the control channel monitoring component 640 is capable of, configured to, or operable to support a means for monitoring for a downlink control channel signal during the communication window based on receiving the LP-WUS during the LP-WUS monitoring occasion.

In some examples, to support transmitting the periodic CSI report, the periodic CSI reporting component 635 is capable of, configured to, or operable to support a means for transmitting the periodic CSI report at each communication window that corresponds to an integer quantity of LP-WUS monitoring occasions of the set of multiple LP-WUS monitoring occasions.

In some examples, the third configuration for the periodic CSI reporting indicates the integer quantity of LP-WUS monitoring occasions.

In some examples, the integer quantity of LP-WUS monitoring occasions is based on a periodicity of the C-DRX cycle.

In some examples, the periodic CSI report is transmitted during each communication window of the set of multiple communication windows.

In some examples, the communication window is a first communication window after an expiration of a periodic CSI reporting timer indicated via the third configuration for the periodic CSI reporting.

In some examples, the periodic CSI reporting component 635 is capable of, configured to, or operable to support a means for transmitting a second periodic CSI report during the on duration of the C-DRX cycle based on a periodicity of the C-DRX cycle.

In some examples, the second periodic CSI report is transmitted during the on duration of the C-DRX cycle based on an absence of a periodic CSI reporting timer in the third configuration for the periodic CSI reporting.

In some examples, the second configuration for the LP-WUS indicates a timer duration for the set of multiple communication windows.

In some examples, the second configuration for the LP-WUS indicates a time offset between each of the set of multiple LP-WUS monitoring occasions and the set of multiple communication windows.

In some examples, the third configuration for the periodic CSI reporting configures the UE to refrain from transmitting the periodic CSI report unless the UE receives the LP-WUS.

In some examples, the third configuration for the periodic CSI reporting configures the UE to transmit the periodic CSI report independent from a reception of the LP-WUS.

In some examples, the periodic CSI report is transmitted during the off duration of the C-DRX cycle.

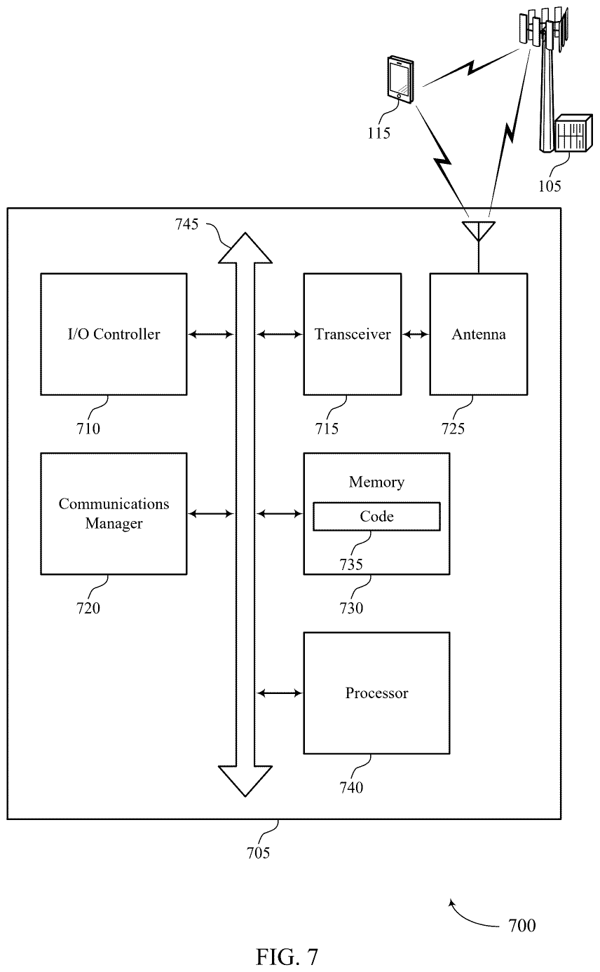

FIG. 7 shows a diagram of a system 700 including a device 705 that supports periodic CSI reporting in a C-DRX cycle in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting periodic CSI reporting in a C-DRX cycle). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving, via a main radio of the UE, a control signal indicating a first configuration for a C-DRX cycle including an on duration and an off duration, a second configuration for a LP-WUS that indicates a set of multiple LP-WUS monitoring occasions and a set of multiple communication windows that correspond to the set of multiple LP-WUS monitoring occasions, and a third configuration for periodic CSI reporting. The communications manager 720 is capable of, configured to, or operable to support a means for monitoring for the LP-WUS using a low power radio of the UE during the set of multiple LP-WUS monitoring occasions based on the first configuration and the second configuration. The communications manager 720 is capable of, configured to, or operable to support a means for transmitting a periodic CSI report during a communication window of the set of multiple communication windows that is associated with a LP-WUS monitoring occasion of the set of multiple LP-WUS monitoring occasions based on the third configuration for the periodic CSI reporting.

By including or configuring the communications manager 720 in accordance with examples as described herein, the device 705 may support techniques for improved communication reliability, reduced latency, and reduced power consumption.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of periodic CSI reporting in a C-DRX cycle as described herein, or the at least one processor 740 and the at least one memory 730 may be otherwise configured to, individually or collectively, perform or support such operations.

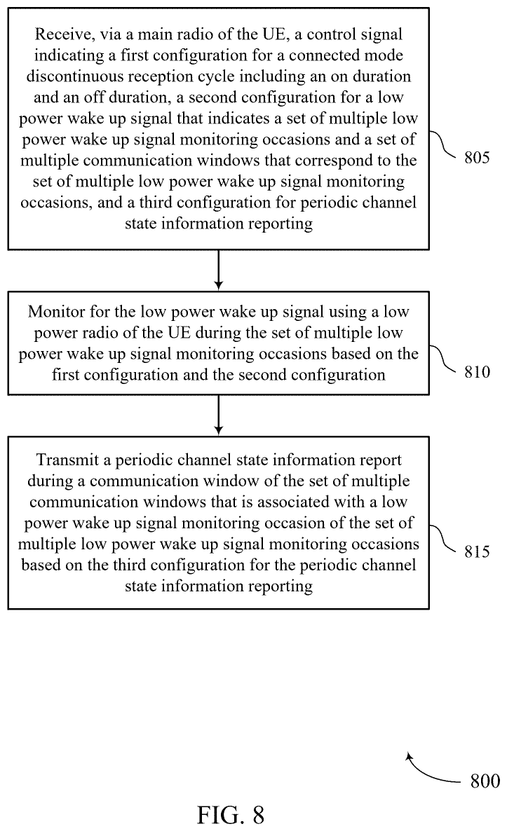

FIG. 8 shows a flowchart illustrating a method 800 that supports periodic CSI reporting in a C-DRX cycle in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving, via a main radio of the UE, a control signal indicating a first configuration for a C-DRX cycle including an on duration and an off duration, a second configuration for a LP-WUS that indicates a set of multiple LP-WUS monitoring occasions and a set of multiple communication windows that correspond to the set of multiple LP-WUS monitoring occasions, and a third configuration for periodic CSI reporting. The operations of 805 may be performed in accordance with examples as disclosed herein. In some examples, aspects of the operations of 805 may be performed by a configuration reception component 625 as described with reference to FIG. 6.

At 810, the method may include monitoring for the LP-WUS using a low power radio of the UE during the set of multiple LP-WUS monitoring occasions based on the first configuration and the second configuration. The operations of 810 may be performed in accordance with examples as disclosed herein. In some examples, aspects of the operations of 810 may be performed by an LP-WUS monitoring component 630 as described with reference to FIG. 6.

At 815, the method may include transmitting a periodic CSI report during a communication window of the set of multiple communication windows that is associated with a LP-WUS monitoring occasion of the set of multiple LP-WUS monitoring occasions based on the third configuration for the periodic CSI reporting. The operations of 815 may be performed in accordance with examples as disclosed herein. In some examples, aspects of the operations of 815 may be performed by a periodic CSI reporting component 635 as described with reference to FIG. 6.

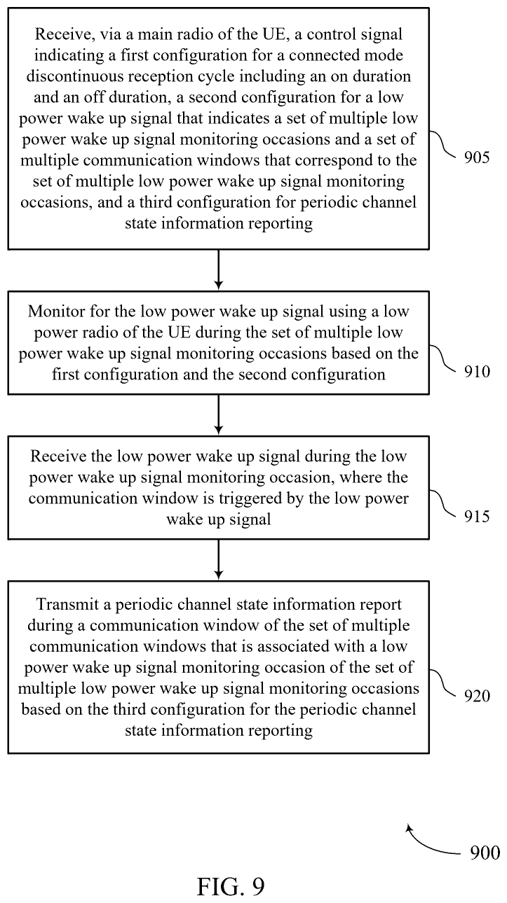

FIG. 9 shows a flowchart illustrating a method 900 that supports periodic CSI reporting in a C-DRX cycle in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving, via a main radio of the UE, a control signal indicating a first configuration for a C-DRX cycle including an on duration and an off duration, a second configuration for a LP-WUS that indicates a set of multiple LP-WUS monitoring occasions and a set of multiple communication windows that correspond to the set of multiple LP-WUS monitoring occasions, and a third configuration for periodic CSI reporting. The operations of 905 may be performed in accordance with examples as disclosed herein. In some examples, aspects of the operations of 905 may be performed by a configuration reception component 625 as described with reference to FIG. 6.

At 910, the method may include monitoring for the LP-WUS using a low power radio of the UE during the set of multiple LP-WUS monitoring occasions based on the first configuration and the second configuration. The operations of 910 may be performed in accordance with examples as disclosed herein. In some examples, aspects of the operations of 910 may be performed by an LP-WUS monitoring component 630 as described with reference to FIG. 6.

At 915, the method may include receiving the LP-WUS during the LP-WUS monitoring occasion, where the communication window is triggered by the LP-WUS. The operations of 915 may be performed in accordance with examples as disclosed herein. In some examples, aspects of the operations of 915 may be performed by an LP-WUS monitoring component 630 as described with reference to FIG. 6.

At 920, the method may include transmitting a periodic CSI report during a communication window of the set of multiple communication windows that is associated with a LP-WUS monitoring occasion of the set of multiple LP-WUS monitoring occasions based on the third configuration for the periodic CSI reporting. The operations of 920 may be performed in accordance with examples as disclosed herein. In some examples, aspects of the operations of 920 may be performed by a periodic CSI reporting component 635 as described with reference to FIG. 6.

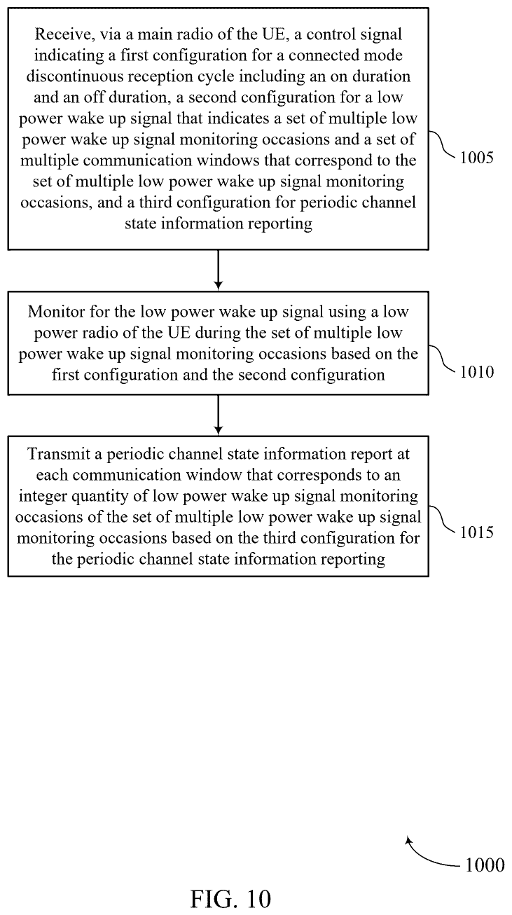

FIG. 10 shows a flowchart illustrating a method 1000 that supports periodic CSI reporting in a C-DRX cycle in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving, via a main radio of the UE, a control signal indicating a first configuration for a C-DRX cycle including an on duration and an off duration, a second configuration for a LP-WUS that indicates a set of multiple LP-WUS monitoring occasions and a set of multiple communication windows that correspond to the set of multiple LP-WUS monitoring occasions, and a third configuration for periodic CSI reporting. The operations of 1005 may be performed in accordance with examples as disclosed herein. In some examples, aspects of the operations of 1005 may be performed by a configuration reception component 625 as described with reference to FIG. 6.

At 1010, the method may include monitoring for the LP-WUS using a low power radio of the UE during the set of multiple LP-WUS monitoring occasions based on the first configuration and the second configuration. The operations of 1010 may be performed in accordance with examples as disclosed herein. In some examples, aspects of the operations of 1010 may be performed by an LP-WUS monitoring component 630 as described with reference to FIG. 6.

At 1015, the method may include transmitting a periodic CSI report at each communication window that corresponds to an integer quantity of LP-WUS monitoring occasions of the set of multiple LP-WUS monitoring occasions based on the third configuration for the periodic CSI reporting. The operations of 1015 may be performed in accordance with examples as disclosed herein. In some examples, aspects of the operations of 1015 may be performed by a periodic CSI reporting component 635 as described with reference to FIG. 6.

The following provides an overview of aspects of the present disclosure:

Aspect 1: A method for wireless communications at a UE, comprising: receiving, via a main radio of the UE, a control signal indicating a first configuration for a connected mode discontinuous reception cycle comprising an on duration and an off duration, a second configuration for a low power wake up signal that indicates a plurality of low power wake up signal monitoring occasions and a plurality of communication windows that correspond to the plurality of low power wake up signal monitoring occasions, and a third configuration for periodic channel state information reporting; monitoring for the low power wake up signal using a low power radio of the UE during the plurality of low power wake up signal monitoring occasions based at least in part on the first configuration and the second configuration; and transmitting a periodic channel state information report during a communication window of the plurality of communication windows that is associated with a low power wake up signal monitoring occasion of the plurality of low power wake up signal monitoring occasions based at least in part on the third configuration for the periodic channel state information reporting.

Aspect 2: The method of aspect 1, wherein monitoring for the low power wake up signal comprises: receiving the low power wake up signal during the low power wake up signal monitoring occasion, wherein the communication window is triggered by the low power wake up signal.

Aspect 3: The method of aspect 2, further comprising: monitoring for a downlink control channel signal during the communication window based at least in part on receiving the low power wake up signal during the low power wake up signal monitoring occasion.

Aspect 4: The method of any of aspects 1 through 3, wherein transmitting the periodic channel state information report comprises: transmitting the periodic channel state information report at each communication window that corresponds to an integer quantity of low power wake up signal monitoring occasions of the plurality of low power wake up signal monitoring occasions.

Aspect 5: The method of aspect 4, wherein the third configuration for the periodic channel state information reporting indicates the integer quantity of low power wake up signal monitoring occasions.

Aspect 6: The method of any of aspects 4 through 5, wherein the integer quantity of low power wake up signal monitoring occasions is based at least in part on a periodicity of the connected mode discontinuous reception cycle.

Aspect 7: The method of any of aspects 4 through 6, wherein the periodic channel state information report is transmitted during each communication window of the plurality of communication windows.

Aspect 8: The method of any of aspects 1 through 7, wherein the communication window is a first communication window after an expiration of a periodic channel state information reporting timer indicated via the third configuration for the periodic channel state information reporting.

Aspect 9: The method of any of aspects 1 through 8, further comprising: transmitting a second periodic channel state information report during the on duration of the connected mode discontinuous reception cycle based at least in part on a periodicity of the connected mode discontinuous reception cycle.

Aspect 10: The method of aspect 9, wherein the second periodic channel state information report is transmitted during the on duration of the connected mode discontinuous reception cycle based at least in part on an absence of a periodic channel state information reporting timer in the third configuration for the periodic channel state information reporting.

Aspect 11: The method of any of aspects 1 through 10, wherein the second configuration for the low power wake up signal indicates a timer duration for the plurality of communication windows.

Aspect 12: The method of any of aspects 1 through 11, wherein the second configuration for the low power wake up signal indicates a time offset between each of the plurality of low power wake up signal monitoring occasions and the plurality of communication windows.

Aspect 13: The method of any of aspects 1 through 12, wherein the third configuration for the periodic channel state information reporting configures the UE to refrain from transmitting the periodic channel state information report unless the UE receives the low power wake up signal.

Aspect 14: The method of any of aspects 1 through 13, wherein the third configuration for the periodic channel state information reporting configures the UE to transmit the periodic channel state information report independent from a reception of the low power wake up signal.

Aspect 15: The method of any of aspects 1 through 14, wherein the periodic channel state information report is transmitted during the off duration of the connected mode discontinuous reception cycle.

Aspect 16: A UE for wireless communications, comprising one or more memories storing processor-executable code, and one or more processors coupled with the one or more memories and individually or collectively operable to execute the code to cause the UE to perform a method of any of aspects 1 through 15.

Aspect 17: A UE for wireless communications, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a main radio of the UE, a control signal indicating a first configuration for a connected mode discontinuous reception cycle comprising an on duration and an off duration, a second configuration for a low power wake up signal that indicates a plurality of low power wake up signal monitoring occasions and a plurality of communication windows that correspond to the plurality of low power wake up signal monitoring occasions, and a third configuration for periodic channel state information reporting;
monitor for the low power wake up signal using a low power radio of the UE during the plurality of low power wake up signal monitoring occasions based at least in part on the first configuration and the second configuration; and
transmit a periodic channel state information report during a communication window of the plurality of communication windows that is associated with a low power wake up signal monitoring occasion of the plurality of low power wake up signal monitoring occasions based at least in part on the third configuration for the periodic channel state information reporting.

2. The UE of claim 1, wherein the second configuration for the low power wake up signal indicates a timer duration for the plurality of communication windows.

3. The UE of claim 1, wherein the second configuration for the low power wake up signal indicates a time offset between each of the plurality of low power wake up signal monitoring occasions and the plurality of communication windows.

4. The UE of claim 1, wherein the one or more processors are individually or collectively further operable to execute the code to cause the UE to:
transmit a second periodic channel state information report during the on duration of the connected mode discontinuous reception cycle based at least in part on a periodicity of the connected mode discontinuous reception cycle.

5. The UE of claim 4, wherein the second periodic channel state information report is transmitted during the on duration of the connected mode discontinuous reception cycle based at least in part on an absence of a periodic channel state information reporting timer in the third configuration for the periodic channel state information reporting.

6. The UE of claim 1, wherein, to monitor for the low power wake up signal, the one or more processors are individually or collectively operable to execute the code to cause the UE to:
receive the low power wake up signal during the low power wake up signal monitoring occasion, wherein the communication window is triggered by the low power wake up signal.

7. The UE of claim 6, wherein the one or more processors are individually or collectively further operable to execute the code to cause the UE to:
monitor for a downlink control channel signal during the communication window based at least in part on receiving the low power wake up signal during the low power wake up signal monitoring occasion.

8. The UE of claim 1, wherein, to transmit the periodic channel state information report, the one or more processors are individually or collectively operable to execute the code to cause the UE to:
transmit the periodic channel state information report at each communication window that corresponds to an integer quantity of low power wake up signal monitoring occasions of the plurality of low power wake up signal monitoring occasions.

9. The UE of claim 8, wherein the third configuration for the periodic channel state information reporting indicates the integer quantity of low power wake up signal monitoring occasions.

10. The UE of claim 8, wherein the integer quantity of low power wake up signal monitoring occasions is based at least in part on a periodicity of the connected mode discontinuous reception cycle.

11. The UE of claim 8, wherein the periodic channel state information report is transmitted during each communication window of the plurality of communication windows.

12. The UE of claim 1, wherein the communication window is a first communication window after an expiration of a periodic channel state information reporting timer indicated via the third configuration for the periodic channel state information reporting.

13. The UE of claim 1, wherein the third configuration for the periodic channel state information reporting configures the UE to refrain from transmitting the periodic channel state information report unless the UE receives the low power wake up signal.

14. The UE of claim 1, wherein the periodic channel state information report is transmitted during the off duration of the connected mode discontinuous reception cycle.

15. A method for wireless communications at a user equipment (UE), comprising:
receiving, via a main radio of the UE, a control signal indicating a first configuration for a connected mode discontinuous reception cycle comprising an on duration and an off duration, a second configuration for a low power wake up signal that indicates a plurality of low power wake up signal monitoring occasions and a plurality of communication windows that correspond to the plurality of low power wake up signal monitoring occasions, and a third configuration for periodic channel state information reporting;
monitoring for the low power wake up signal using a low power radio of the UE during the plurality of low power wake up signal monitoring occasions based at least in part on the first configuration and the second configuration; and
transmitting a periodic channel state information report during a communication window of the plurality of communication windows that is associated with a low power wake up signal monitoring occasion of the plurality of low power wake up signal monitoring occasions based at least in part on the third configuration for the periodic channel state information reporting.

16. The method of claim 15, wherein the second configuration for the low power wake up signal indicates a timer duration for the plurality of communication windows.

17. The method of claim 15, wherein the second configuration for the low power wake up signal indicates a time offset between each of the plurality of low power wake up signal monitoring occasions and the plurality of communication windows.

18. The method of claim 15, further comprising:
transmitting a second periodic channel state information report during the on duration of the connected mode discontinuous reception cycle based at least in part on a periodicity of the connected mode discontinuous reception cycle.

19. The method of claim 15, wherein monitoring for the low power wake up signal comprises:
receiving the low power wake up signal during the low power wake up signal monitoring occasion, wherein the communication window is triggered by the low power wake up signal.

20. A non-transitory computer-readable medium storing code for wireless communications, the code comprising instructions executable by one or more processors to:
receive, via a main radio of a user equipment (UE), a control signal indicating a first configuration for a connected mode discontinuous reception cycle comprising an on duration and an off duration, a second configuration for a low power wake up signal that indicates a plurality of low power wake up signal monitoring occasions and a plurality of communication windows that correspond to the plurality of low power wake up signal monitoring occasions, and a third configuration for periodic channel state information reporting;
monitor for the low power wake up signal using a low power radio of the UE during the plurality of low power wake up signal monitoring occasions based at least in part on the first configuration and the second configuration; and
transmit a periodic channel state information report during a communication window of the plurality of communication windows that is associated with a low power wake up signal monitoring occasion of the plurality of low power wake up signal monitoring occasions based at least in part on the third configuration for the periodic channel state information reporting.
